(19) United States
(12) Patent Application Publication
(10) Pub. No.: US 2026/0322652 A1
(43) Pub. Date: Oct. 15, 2026

(54) TRANSCEIVER FOR A SUBSCRIBER STATION OF A SERIAL BUS SYSTEM AND METHOD FOR RECEIVING DIFFERENTIAL SIGNALS IN A SERIAL BUS SYSTEM

(71) Applicant: Robert Bosch GmbH, Stuttgart (DE)

(72) Inventors: Steffen Walker, Reutlingen (DE); Martin Frey, Rohrdorf (DE)

(21) Appl. No.: 19/111,151

(22) PCT Filed: Oct. 25, 2023
(86) PCT No.: PCT/EP2023/079759

§ 371 Date: Mar. 12, 2025

(30) Foreign Application Priority Data
Dec. 13, 2022 (DE) 10 2022 213 573.3

(51) Int. Cl. H04L 12/417; H04L 12/40

(52) U.S. Cl. CPC H04L 12/417; H04L 12/40176

(57) ABSTRACT

A transceiver for a subscriber station of a serial bus. In the bus system, differential signals are generated on a bus of the bus system in a first communication phase of a communication on the bus with a first physical layer and in a second communication phase of the communication with a second physical layer. The transceiver includes a first comparator for evaluating the differential signals received from the bus with a first receive threshold in the first communication phase and with a third receive threshold in the second communication phase. The first comparator is configured to output an output signal to output a digital reception signal to a communication control device of the subscriber station. A second comparator evaluates the differential signals with a second receive threshold in the first communication phase for the reception signal driver. A masking block generates a masked comparator signal.

### FIELD

The present invention relates to a transceiver for a subscriber station of a serial bus system and a method for receiving differential signals in a serial bus system which can be used in a transceiver.

### BACKGROUND INFORMATION

Serial bus systems are used to transmit messages or data in technical systems. A serial bus system can enable communication between sensors and control devices in a vehicle or technical production plant, etc., for instance.

In a CAN bus system, messages are transmitted using the CAN and/or CAN FD protocol as described in the ISO 11898-1:2015 standard as a CAN protocol specification with CAN FD. In CAN FD, the transmission on the bus switches back and forth between a slow operating mode in a first communication phase (arbitration phase) and a fast operating mode in a second communication phase (data phase). In a CAN FD bus system, a data transmission rate of more than 1 Mbit per second (1 Mbps) is possible in the second communication phase. Most manufacturers use CAN FD in the vehicle at a 500 kbit/s arbitration bit rate and a 2 Mbit/s data bit rate in the first step.

To enable even higher data rates in the second communication phase, there are successor bus systems for CAN FD, such as CAN SIC and CAN XL. In CAN SIC according to the CiA601-4 standard, a data rate of approximately 5 to 8 Mbit/s can be achieved in the second communication phase. CAN XL requires a data rate of >10 Mbit/s in the second communication phase. A CiA610-3 standard is currently defined by the CAN in Automation (CiA) organization for CAN XL.

In all of the aforementioned CAN-based bus systems, a bus signal CAN_H and, ideally simultaneously, a bus signal CAN_L are separately driven onto a bus for a transmission signal TxD. At least in the first communication phase, a bus state is actively driven in the bus signals CAN_H, CAN_L. The other bus state is not driven and results from a terminating resistor for bus lines or bus wires of the bus.

Typically, transceivers, which are also referred to as CAN transceivers or CAN FD transceivers, etc., are used in a CAN bus system for the individual communication participants to transmit and receive the bus signals. In CAN XL, the transceivers have to be able to transmit the bus signals CAN_H, CAN_L onto the bus in the second communication phase using a different physical layer and to receive them using a different receive threshold than in the first communication phase. The physical layer corresponds to the bit transmission layer or layer 1 of the conventional OSI (Open Systems Interconnection) model. The physical layer of a CAN XL transceiver is currently defined in the CiA610-3 standard.

The data can thus be transmitted to the bus at a significantly higher data rate in the second communication phase than in the first communication phase. The bus levels of the bus signals CAN_H, CAN_L for the first communication phase can therefore also differ from the bus levels of the second communication phase. To keep the error rate low, it is important that a subscriber station that is newly connected to the communication on the bus identifies in which communication phase communication is currently taking place on the bus.

For all operational phases of communication on the bus, it is therefore necessary to ensure that a receiving subscriber station of the bus system is able to correctly identify and evaluate the levels of the bus signals CAN_H, CAN_L.

### SUMMARY

An object of the present invention is to provide a transceiver for a subscriber station of a serial bus system and a method for receiving differential signals in a serial bus system which solve the aforementioned problems. The transceiver and the method are in particular intended to enable reliable and uncomplicated detection of bus signals, even if the transceiver is not the transmitter of the message currently being transmitted on the bus and the physical layer is being switched between two communication phases during communication on the bus.

The object may be achieved by a transceiver for a subscriber station of a serial bus system having certain features of the present invention. In the bus system, differential signals are generated on a bus of the bus system in a first communication phase of a communication on the bus with a first physical layer and in a second communication phase of the communication on the bus with a second physical layer. According to an example embodiment of the present invention, the transceiver comprises a first comparator for evaluating the differential signals received from the bus with a first receive threshold in the first communication phase and for evaluating differential signals received from the bus with a third receive threshold in the second communication phase, wherein the first comparator is configured to output an output signal in order to output a digital reception signal to a communication control device of the subscriber station, a second comparator for evaluating the differential signals received from the bus with a second receive threshold in the first communication phase for the reception signal driver, and a masking block for generating a masked comparator signal that is an intermittently masked output signal of the second comparator and for generating an output signal from the masked comparator signal and the output signal of the first comparator for the reception signal driver.

The described transceiver of the present invention is configured such that reliable and uncomplicated detection of bus signals takes place during operation of the bus system. This applies in particular also to communication in which the transceiver is not the transmitter of the message currently being transmitted on the bus and the physical layer is being switched between two communication phases during communication on the bus. The transceiver is able to reliably distinguish the respective bus states of the individual communication phases and thus the individual communication phases during communication on the bus.

The described transceiver of the present invention thus makes it possible to meet the specifications for communication in accordance with the requirements of CAN XL which are in particular codified in the CiA610-3 standard. Even if signals with a bit time of approx. 50 ns are to be received from the bus, which corresponds to a transmission rate of approximately 20 Mbit/s on the bus, the transceiver nonetheless requires a comparatively inexpensive receive comparator as the second receive comparator. The reason for this is that the comparator does not require the very high bandwidth needed to receive signals with a bit time of approx. 50 ns or less.

The described transceiver of the present invention is furthermore configured such that the signal levels of the bus signals can be converted into a digital reception signal with simultaneous evaluation of two receive thresholds. The two receive thresholds used in the individual communication phases can be different for each communication phase.

The transceiver of the present invention thus ensures that its higher-level subscriber station, which is newly connected and is being added after an error, for example, and is attempting to integrate itself into the communication on the bus, does not disrupt communication on the bus. This is because the subscriber station can use the transceiver to reliably detect whether the bus is free of data traffic. Since the transceiver reliably assigns the current bus states, its subscriber station that has just been connected to the bus communication will itself transmit data to the bus only when the bus is free. Connecting a subscriber station that is initially started, for example, or is trying to reintegrate itself into the communication on the bus after an error in the bus communication, thus does not lead to a disruption of the communication on the bus.

As a result, the transceiver of the present invention enables the functionality of using different receive thresholds for the arbitration phase and the data phase. This not only enables communication in the bus system to be implemented at higher bit rates, but also ensures that the transmittable bit rate is not reduced by errors in the communication.

Advantageous further example embodiments of the transceiver of the present invention are disclosed herein.

According to an example embodiment of the present invention, the masking block can comprise a timing element which is connected to an output of the second comparator and is configured to output the masked comparator signal and a logic circuit which is configured to generate a signal from the output signal of the first comparator and the masked comparator signal for output to the reception signal driver.

According to an example embodiment of the present invention, the logic circuit is optionally an AND gate in order to serially form a logical AND connection of the output signal of the first comparator and the masked comparator signal.

The transceiver may also have a driver for driving a digital reception signal to a communication control device of a subscriber station of the bus system, and a reception signal logic circuit for forwarding an output signal from a first comparator line comprising the first comparator and an output signal from a second comparator line comprising the second comparator to the driver when the communication is taking place in the first communication phase, and to only forward the output signal from the first comparator line to the driver when the communication is taking place in the second communication phase.

The transceiver may also have a first voltage divider which connected to the bus and outputs the differential signals received from the bus to the first comparator, and a second voltage divider which is connected to the bus and outputs the differential signals received from the bus to the second comparator.

According to an example embodiment of the present invention, the first and second voltage divider can each comprise a circuit of resistors to which the first and second comparator are connected, wherein the first and second comparator evaluate the differential signals simultaneously.

According to an example embodiment of the present invention, the first voltage divider can comprise a switch which is provided to set the first receive threshold for the first voltage divider in a first switch position and to set the third receive threshold for the first voltage divider in a second switch position, and wherein the second voltage divider is configured to set the second receive threshold.

The switching unit can be provided to connect or disconnect a resistor to ground.

The switching unit is optionally an NMOS transistor.

In a special embodiment of the present invention, the transceiver is configured to output the output signal of the second comparator to the reception signal driver when the switch in its first switch position has set the first receive threshold in the first voltage divider, wherein the transceiver can further be configured to not output the output signal of the second comparator to the reception signal driver when the switch in its second switch position has set the third receive threshold in the first voltage divider.

It is possible that the transceiver also has an operating mode setting unit for controlling the switch to switch the first voltage divider between the first and third receive threshold depending on whether the first or second communication phase is taking place on the bus.

According to an example embodiment of the present invention, the transceiver may also have a transmitter module for transmitting signals to a bus of the bus system.

The above-described transceiver can be part of a subscriber station for a serial bus system. The subscriber station can also comprise a communication control device for controlling the communication in the bus system and for generating a digital transmission signal for the transmitter module.

The subscriber station can optionally be configured for communication in a bus system in which exclusive, collision-free access of a subscriber station to the bus of the bus system is ensured at least temporarily.

The aforementioned object may also achieved by a method for receiving differential signals in a serial bus system having certain features of the present invention. In the bus system, differential signals are generated on a bus of the bus system in a first communication phase of a communication on the bus with a first physical layer and in a second communication phase of the communication on the bus with a second physical layer. According to an example embodiment of the present invention, the method comprises the steps of receiving, with a transceiver, differential signals from the bus, evaluating, with a first comparator, the differential signals received from the bus with a first receive threshold in the first communication phase, evaluating, with the first comparator, the differential signals received from the bus with a third receive threshold in the second communication phase, wherein the first comparator outputs a digital reception signal to a communication control device of the subscriber station in order to output an output signal in the first and second communication phases, and evaluating, with a second comparator, the differential signals received from the bus with a second receive threshold in the first communication phase for the reception signal driver, and generating, with a masking block, a masked comparator signal that is an intermittently masked output signal of the second comparator, and generating, with the masking block, an output signal from the masked comparator signal and the output signal of the first comparator for the reception signal driver.

The method of the present invention provides the same advantages as those mentioned above with reference to the transceiver of the present invention.

Other possible implementations of the present invention also include not explicitly mentioned combinations of features or embodiments of the present invention described above or in the following with respect to the embodiment examples. The person skilled in the art will also add individual aspects as improvements or additions to the respective basic form of the present invention.

### BRIEF DESCRIPTION OF THE DRAWINGS

The present invention is described more detail in the following with reference to the figures and on the basis of embodiment examples.

FIG. 1 shows a simplified block diagram of a bus system according to a first embodiment example of the present invention.

FIG. 2 shows a diagram to illustrate the structure of a message that can be transmitted from subscriber stations of the bus system according to the first embodiment example of the present invention.

FIG. 3 shows an example of the ideal time profile of bus signals CAN_H, CAN_L in the bus system of FIG. 1.

FIG. 4 shows the time profile of a differential voltage VDIFF that forms on the bus of the bus system as a result of the bus signals of FIG. 4.

FIG. 5 shows a simplified block diagram of a transceiver with a receiver module for a subscriber station of the bus system according to the first embodiment example of the present invention.

FIG. 6 shows a circuit diagram of a receiver module according to a first embodiment example of the present invention.

FIG. 7 shows the time profile of a differential voltage VDIFF that forms on the bus of the bus system as a result of the transceiver of FIG. 5.

FIG. 8 shows the time profile of a reception signal formed by the receiver module of FIG. 6 from the signal of FIG. 7 received from the bus when a timing element of the receiver module is inactive.

FIG. 9 shows the time profile of a reception signal formed by the receiver module of FIG. 6 from the signal of FIG. 7 received from the bus when the timing element of the receiver module is active.

FIG. 10 shows an example of a time profile of a digital transmission signal which is to be converted into bus signals CAN_H, CAN_L for a bus of the bus system of FIG. 1 in the arbitration phase (SIC operating mode) according to a second embodiment example of the present invention.

FIG. 11 shows the time profile of the bus signals CAN_H, CAN_L when changing between a recessive bus state to a dominant bus state and back into the recessive bus state, which are transmitted to the bus in the arbitration phase (SIC operating mode) based on the transmission signal of FIG. 10.

FIG. 12 shows an example of a time profile of a digital transmission signal which is to be converted into bus signals CAN_H, CAN_L for the bus of the bus system of FIG. 1 in the data phase according to a second embodiment example of the present invention.

FIG. 13 shows the time profile of the bus signals CAN_H, CAN_L which are transmitted to the bus in the data phase based on the transmission signal of FIG. 12.

In the figures, the same or functionally similar elements are provided with the same reference signs unless stated otherwise.

### DETAILED DESCRIPTION OF EXAMPLE EMBODIMENTS

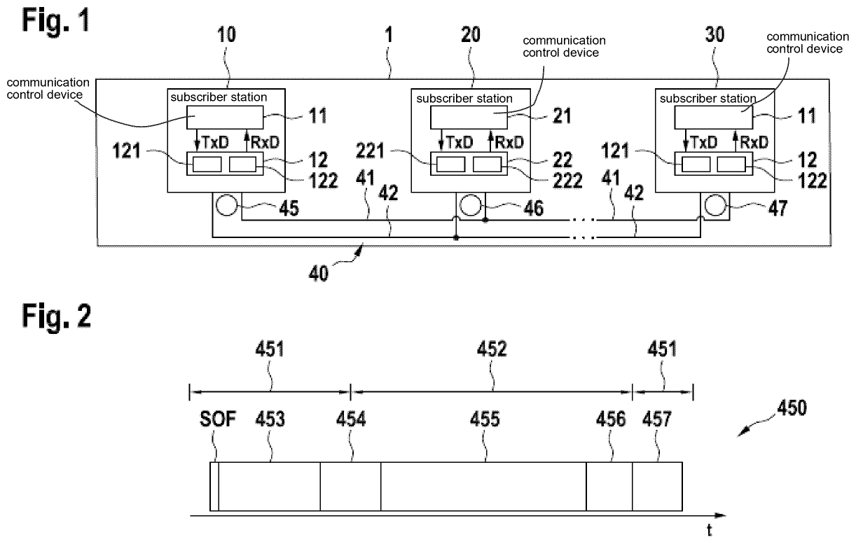

FIG. 1 shows a bus system 1 that can, for instance, at least partly be a CAN bus system, a CAN FD bus system, etc. The bus system 1 can be used in a vehicle, in particular a motor vehicle, an aircraft, etc., or in a hospital, etc.

The bus system 1 in FIG. 1 comprises a plurality of subscriber stations 10, 20, 30 that are all connected to a bus 40 or bus line with a first bus wire 41 and a second bus wire 42. The bus wires 41, 42 can also be referred to as CAN_H and CAN_L for the signals on the bus 40. Messages 45, 46, 47 in the form of signals can be transmitted between the individual subscriber stations 10, 20, 30 via the bus 40. The subscriber stations 10, 20, 30 can, for example, be control devices or display devices of a motor vehicle.

As shown in FIG. 1, the subscriber stations 10, 30 each have a communication control device 11 and a transceiver 12. The transceiver 12 comprises a transmitter module 121 and a receiver module 122.

The subscriber station 20 comprises a communication control device 21 and a transceiver 22. The transceiver 22 comprises a transmitter module 221 and a receiver module 222.

The transceivers 12 of the subscriber stations 10, 30 and the transceiver 22 of the subscriber station 20 are each connected directly to the bus 40, even if this is not shown in FIG. 1.

The communication control devices 11, 21, are all used to control communication of the respective subscriber station 10, 20, 30 via the bus 40 with at least one other subscriber station of the subscriber stations 10, 20, 30 that are connected to the bus 40.

The communication control devices 11 create and read first messages 45, 47 which are modified CAN messages 45, 47 for instance. The structure of the modified CAN messages 45, 47 is based on the CAN XL format, for example. The transceiver 12 is used to transmit and receive the messages 45, 47 from the bus 40. The transmitter module 121 receives a digital transmission signal TxD created by the communication control device 11 for one of the messages 45, 47 and converts it into signals on the bus 40. The receiver module 121 receives signals transmitted on the bus 40 corresponding to the messages 45 to 47 and from them generates a digital reception signal RxD. The receiver module 122 transmits the reception signal RxD to the communication control device 11.

The communication control device 21 can be designed like a conventional CAN controller according to ISO 11898-1:2015, i.e. like a CAN FD tolerant Classical CAN Controller or a CAN FD controller. the communication control device 21 creates and reads second messages 46, for example CAN FD messages 46. The transceiver 22 is used to transmit and receive the messages 46 from the bus 40. The transmitter module 221 receives a digital transmission signal TxD created by the communication control device 21 and converts it into signals for a message 46 on the bus 40. The receiver module 221 receives signals transmitted on the bus 40 corresponding to the messages 45 to 47 and from them generates a digital reception signal RxD. Otherwise, the transceiver 22 can be embodied like a conventional CAN transceiver.

To transmit the messages 45, 47 with CAN SIC or CAN XL, proven properties that are responsible for the robustness and user friendliness of CAN and CAN FD, in particular frame structure with identifier and arbitration according to the conventional CSMA/CR method, are adopted. The CSMA/CR method necessitates the existence of so-called recessive states on the bus 40 that can be overwritten by other subscriber stations 10, 20, 30 with dominant levels or dominant states on the bus 40.

The two subscriber stations 10, 30 make it possible to form and then transmit messages 45 with various CAN formats, in particular the CAN FD format or the CAN SIC format or the CAN XL format, and also receive such messages 45 as described in more detail in the following.

FIG. 2 shows a frame 450 for the message 45 which is in particular a CAN XL frame as provided by the communication control device 11 for the transceiver 12 for transmission to the bus 40. In the present embodiment example, the communication control device 11 creates the frame 450 as compatible with CAN FD. The frame 450 is alternatively compatible with CAN SIC.

According to FIG. 2, the frame 450 for CAN communication on the bus 40 is divided into different communication phases 451, 452, namely an arbitration phase 451 (first communication phase) and a data phase 452 (second communication phase). After a start bit SOF, the frame 450 has an arbitration field 453, a control field 454 in which switching from the arbitration phase 451 to the data phase 452 takes place, a data field 455, a checksum field 456 and a frame termination field 457.

In the arbitration phase 451, an identifier (ID), for example with bits ID28 to ID18 in the arbitration field 453, is used to negotiate bit by bit between the subscriber stations 10, 20, 30 which subscriber station 10, 20, 30 wants to transmit the message 45, 46 with the highest priority and therefore receive exclusive access to the bus 40 of the bus system 1 for the next transmission time in the subsequent data phase 452. In the arbitration phase 451, a physical layer is used as in CAN and CAN FD. The physical layer corresponds to the bit transmission layer or layer 1 of the conventional OSI (Open Systems Interconnection) model.

A key point during phase 451 is the use of the conventional CSMA/CR method, which permits simultaneous access of the subscriber stations 10, 20, 30 to bus 40 without destroying the higher-priority message 45, 46. This makes it relatively easy to add further bus subscriber stations 10, 20, 30 to the bus system 1, which is very advantageous.

The CSMA/CR method necessitates the existence of so-called recessive states on the bus 40 that can be overwritten by other subscriber stations 10, 20, 30 with dominant levels or dominant states on the bus 40. In the recessive state, high-ohmic conditions prevail at the individual subscriber station 10, 20, 30, which in combination with the parasites of the bus circuitry results in longer time constants. This leads to a limitation of the maximum bit rate of the present-day CAN FD physical layer to currently approximately 2 megabits per second in real vehicle use.

In the data phase 452, the useful data of the CAN XL frame 450 or the message 45 are transmitted from the data field 455 and the checksum field 456 in addition to a part of the control field 454. The checksum field 456 can contain a checksum across the data of the data phase 452 including the stuff bits which are inserted as an inverse bit by the transmitter of the message 45 after a predetermined number of identical bits, in particular 10 identical bits. At the end of the data phase 452, the system switches back to the arbitration phase 451.

At least one acknowledge bit can be included in an end field in the frame termination phase 457. A sequence of 11 identical bits can be present as well, which indicates the end of the CAN XL frame 450. The at least one acknowledge bit can be used to indicate whether or not a receiver has detected an error in the received CAN XL frame 450 or the message 45.

A transmitter of the message 45 does not start transmitting bits of the data phase 452 to the bus 40 until the subscriber station 10 as the transmitter has won the arbitration and the subscriber station 10 as the transmitter thus has exclusive access to the bus 40 of the bus system 1 for transmission.

Thus, in the arbitration phase 451 as the first communication phase, the subscriber stations 10, 30 partly, in particular up to (including) the FDF bit, use a format as from CAN/CAN FD in accordance with ISO 11898-1:2015. In comparison to CAN or CAN FD, however, an increase in the net data transmission rate, in particular to more than 10 megabits per second, is possible in the data phase 452 as the second communication phase. It is also possible to increase the size of the useful data per frame, in particular to approximately 2 kbytes or any other value.

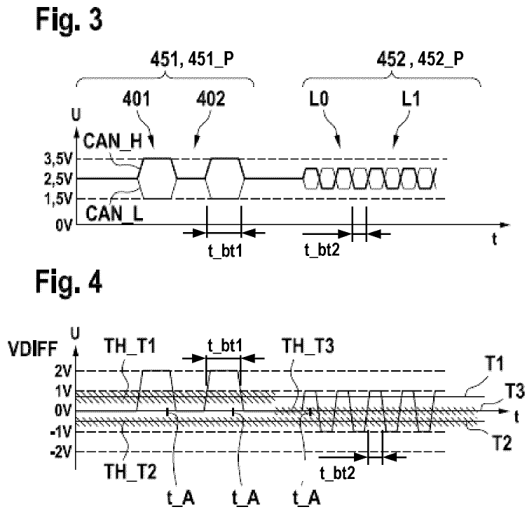

On the left side, FIG. 3 shows that, in the arbitration phase 451 with a first physical layer 451_P, the subscriber stations 10, 20, 30 each transmit signals CAN_H, CAN_L to the bus 40 over the time t, which have a first bit duration t_bt1. The signals CAN_H, CAN_L are serial signals and alternately have at least one dominant state 401, in which VCAN_H=3.5 V and VCAN_L=1.5 V, or at least one recessive state 402, in which VCAN_H=VCAN_L=2.5. In the case of NRZ encoding of the transmission signal TXD, dominant states 401 are driven in the phase 451 if TXD=0 or L (LOW). In the case of NRZ encoding of the transmission signal TXD, recessive states 402 are generated or arise in the phase 451 if TXD=1 or HI (HIGH). After arbitration in the arbitration phase 451, one of the subscriber stations 10, 20, 30 is established the winner.

If the subscriber stations 10, 20, 30 detect a signal in the control field 454 of FIG. 3 to switch from the first to the second communication phase 451, 452, the respective transceiver 12 switches its physical layer 451_P at the end of the arbitration phase 451 from a first operating mode (SLOW), which can also be implemented as a SIC operating mode, to the physical layer 452_P of the data phase 452 as shown on the right in FIG. 3. For this purpose, the operating modes of the data phase 452 are switched on as follows.

Let it be assumed that the subscriber station 10 has won the arbitration. The transceiver 12 of the subscriber station 10 then switches its physical layer 451_P at the end of the arbitration phase 451 from a first operating mode (SLOW) to the physical layer 452_P for a second operating mode (FAST_TX) because, in the data phase 452, the subscriber station 10 is the transmitter of the message 45. In the data phase 452 or in the second operating mode (FAST_TX), the transmitter module 121 then generates the states L0 or L1 for the signals CAN_H, CAN_L on the bus 40 successively and thus serially depending on a transmission signal TxD. For a pulse width modulation (PWM encoding) of the transmission signal TXD, the state L0 (VCAN_H=3.0 V, VCAN_L=2.0 V) is driven in the transmission signal TXD for a first PWM symbol. For the pulse width modulation (PWM encoding) of the transmission signal TXD, the state L1 (VCAN_H=2.0 V and VCAN_L=3.0 V) is driven in the transmission signal TXD for a second PWM symbol which differs from the first PWM symbol.

The frequency of the signals CAN_H, CAN_L can be increased in the data phase 452 as shown on the right side in FIG. 3. For this purpose, the bit time or bit duration t_bt2 in the data phase 452 in the example of FIG. 3 is shorter or less than the bit time or bit duration t_bt1 in the arbitration phase 451. The net data transmission rate in the data phase 452 in the example of FIG. 3 is thus increased in comparison to the arbitration phase 451.

The transceiver 12 of the subscriber station 30, on the other hand, switches its physical layer 451_P at the end of the arbitration phase 451 from a first operating mode (SLOW) to the physical layer 452_P for a third operating mode (FAST_RX) because, in the data phase 452, the subscriber station 30 is only the receiver, i.e. not a transmitter, of the frame 450. After the end of the data phase 452, all of the transceivers 12 of the subscriber stations 10, 30 switch their operating mode to the first operating mode (SLOW). All of the transceivers 12 consequently also switch their physical layer.

According to FIG. 4, in the ideal case, a differential signal VDIFF=CAN_H−CAN_L with values of VDIFF=2 V for dominant states 401 and VDIFF=0 V for recessive states 402 forms on the bus 40 in the arbitration phase 451. This is shown on the left side in FIG. 4. In the data phase 452, on the other hand, a differential signal VDIFF=CAN_H−CAN_L with states L0, L1 forms on the bus 40 as shown on the right in FIG. 4. The state L0 has a value VDIFF=1 V. The state L1 has a value VDIFF=−1 V.

The receiver module 122 can distinguish the states 401, 402, in each case using two of the receive thresholds T1, T2, T3 that lie in the ranges TH_T1, TH_T2, TH_T3. For this purpose, the receiver module 122 samples the signals of FIG. 3 or FIG. 4 at times t_A. To evaluate the sampling result, in the arbitration phase 451, the receiver module 122 uses the receive threshold T1 of 0.7 V, for example, and the receive threshold T2 of −0.35 V, for example. In the data phase 452, on the other hand, the receiver module 122 only uses signals that were evaluated with the receive threshold T3. When switching between the first to third operating modes (SLOW, FAST_TX, FAST_RX) described above with reference to FIG. 3, the receiver module 122 always switches the receive thresholds T2, T3 as described in the following.

The receive threshold T2 is used to detect whether the bus 40 is free when the subscriber station 12 is newly connected to the communication on the bus 40 and is attempting to integrate itself into the communication on the bus 40. In the standard for CAN, the receive threshold T2 is abbreviated to OOB (out-of-boundary=outside the limit value). The conditions for a traffic-free CAN XL bus are that no dominant state 401 occurs, which typically has the differential voltage VDIFF=2 V. The receive threshold T1 of 0.7 V, for example, may therefore not be exceeded. No levels according to the state L1, which typically has the differential voltage VDIFF=2 V−1 V, may occur either. The receive threshold T2 of −0.35 V, for example, may therefore not be undershot.

Each subscriber station 10, 30 switches the operating mode of the transceiver 12 to the operating mode of the arbitration phase 451 when the subscriber station 12 is newly connected to the communication on the bus 40.

On the one hand, connecting the subscriber station 10 may be necessary when the subscriber station 10 is initially started and is to be integrated into the communication on the bus 40. On the other hand, connecting the subscriber station 10 may be necessary when the subscriber station 10 is attempting to reintegrate itself into the communication on the bus 40 after an error in the bus communication. In the cases mentioned, the subscriber station 10 may transmit data, in particular messages 45, 47, to the bus 40 only when it is detected that the bus is free. For this purpose, there is a check to ensure that there is no dominant level on the bus 40, i.e. the receive threshold T1 is not being exceeded. There is also a check to ensure that there is neither a L0 nor a L1 level on the bus 40. Depending on the transceiver transmission level, the threshold T1 can be exceeded by levels for states 401 (dom) and the state L0. For this reason, the threshold T2 is used, which carries out detection via the states L0.

The following table 1 shows the values that can be set for the individual receive thresholds on the bus 40. VDIFF_min specifies the lower limit for the individual ranges TH_T1, TH_T2, TH_T3 that can be set as a minimum for the corresponding receive threshold T1, T2, T3 in V. VDIFF_typ specifies the value that is typically or usually set for the corresponding receive threshold T1, T2, T3 in V. VDIFF_max specifies the upper limit for the individual ranges TH_T1, TH_T2, TH_T3 that can be set as a maximum for the corresponding receive threshold T1, T2, T3 in V.

TABLE 1
Tolerance ranges of receive thresholds T1, T2, T3

| Receive | VDIFF_min | VDIFF_typ | VDIFF_max | Tolerance |
|---|---|---|---|---|
| threshold | in V | in V | in V | in V |
| T1 | 0.5 | 0.7 | 0.9 | +/−0.2 |
| T2 | −0.45 | −0.35 | −0.25 | +/−0.1 |
| T3 | −0.1 | 0.0 | +0.1 | +/−0.1 |

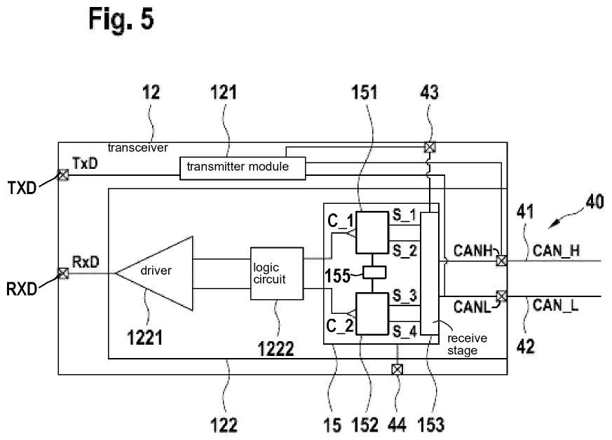

FIG. 5 shows the basic structure of the transceiver 12 of the subscriber station 10. The transmitter module 121 is shown only in a very simplified form. The transmitter module 121 is connected directly to the bus 40 in order to be able to transmit the transmission signal TxD of the communication control device 11 to the bus 40 to generate signals according to FIG. 3 on the bus 40.

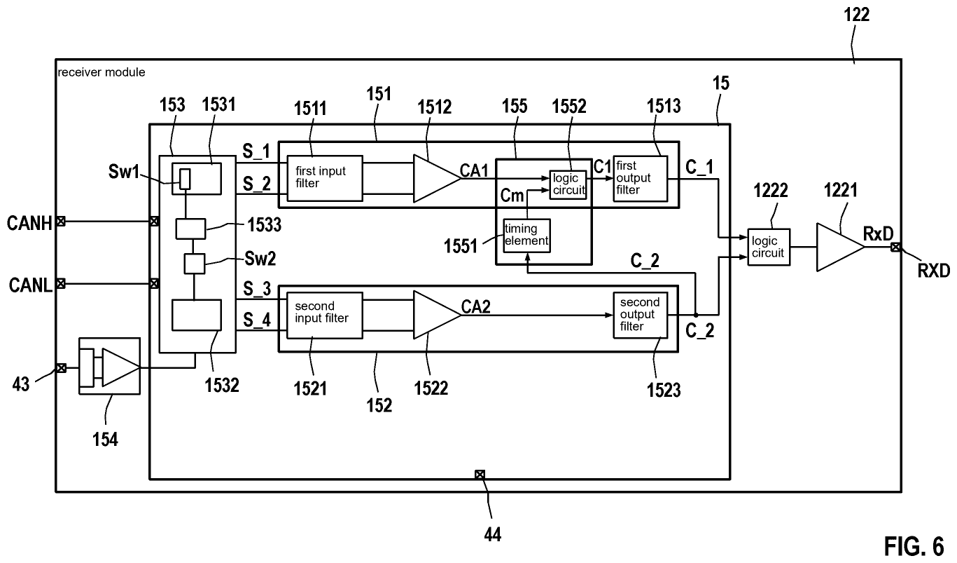

The receiver module 122 comprises a driver 1221 for the digital reception signal RxD, a logic circuit 1222, and a receiver circuit 15. The receiver circuit 15 comprises a first receive comparator line 151, a second receive comparator line 152, a receive stage 153 and a masking block 155. The receive comparators 151, 152 are respective receive comparator lines with a low-voltage comparator. This is explained in more detail with reference to FIG. 6.

According to FIG. 5, the receiver circuit 15 is connected between the bus 40 and the logic circuit 1222. The driver 1221 is connected to the output of the logic circuit 1222. The driver 1221 drives or transmits the digital reception signal RxD to the communication control device 11.

In the receiver circuit 15, the receive stage 153 is connected to the bus 40. During operation of the bus system 1, the receive stage 153 generates signals S_1, S_2 from the signals CAN_H, CAN_L and forwards them to the first receive comparator line 151. The first receive comparator line 151 generates a comparator output signal C_1 from the signals S_1, S_2.

During operation of the bus system 1, the receive stage 153 also generates signals S_3, S_4 from the signals CAN_H, CAN_L and forwards them to the second receive comparator line 152. The second receive comparator line 152 generates a comparator output signal C_2 from the signals S_3, S_4.

The logic circuit 1222 is configured to output the signal C_1 and the signal C_2 to the driver 1221 or to output only the signal C_2 to the driver 1221 depending on the operating mode of the transceiver 12. The operating mode of the transceiver 12, in particular its receiver module 122, is one of the first to third operating mode (SLOW, FAST_TX, FAST_RX) as described above. For this purpose, the logic circuit 1222 can comprise or be at least one AND gate. The logic circuit 1222 alternatively comprises other logic components to fulfill the function of the receiver module 122 described in the following.

The receive stage 153, masking block 155 and their interconnection with the logic circuit 1222 are described in more detail with reference to FIG. 6.

As shown in FIG. 6, the receiver circuit 15 also comprises a bus bias source (bus biasing) 154 which supplies a voltage CAN_SUPPLY/2 to the receive stage 153. Typically CAN_SUPPLY=5 V. In this case, the bus bias source 154 supplies a voltage of 2.5 V to the receive stage 153.

The first receive comparator line 151 comprises a first input filter 1511, a first comparator 1512 which outputs a digital output signal CA1, and a first output filter 1513 which outputs a digital output signal C_1. The second receive comparator line 152 comprises a second input filter 1521, a second comparator 1522 which outputs a digital output signal CA2, and a second output filter 1523 which outputs a digital output signal C_2. The filters 1511, 1523, 1521, 1523 each filter interference from the signals that are input to the respective filter 1511, 1523, 1521, 1523. Each of the receive comparators 1512, 1522 is a low-voltage comparator.

The masking block 155 is connected between the receive comparator lines 151, 152. The masking block 155 comprises a timing element 1551 which outputs a digital signal CM and a logic circuit 1552 which outputs a digital signal Cl. The logic circuit 1552 can comprise or be at least one AND gate. The logic circuit 1552 alternatively comprises other logic components to fulfill the function of the receiver module 122 described in the following.

The receive stage 153 comprises a first voltage divider 1531 with a first switch Sw1, a second voltage divider 1532, an operating mode setting unit 1533 and an optional second switch Sw2. The first and second voltage divider 1531, 1532 are each supplied with the same voltage from the bus bias source 154, in particular 2.5 V for the recessive state 402 (FIG. 3). The second switch Sw2 can optionally switch off the second voltage divider 1532.

The first voltage divider 1531 and the second voltage divider 1532 are resistive voltage dividers or resistor voltage dividers, for instance, which each comprise a plurality of resistors that form a resistor network. The first voltage divider 1531 and the second voltage divider 1532 each comprise a resistor that is connected to ground (CAN_GND) or the terminal 44, even if this is not shown in detail in FIG. 6.

The first voltage divider 1531 can set the receive threshold T1 of FIG. 4, for instance, or the receive threshold T3 of FIG. 4. The outputs of the first voltage divider 1531 are connected to the inputs of the first input filter 1511. The switch Sw1, which is controlled by the operating mode setting unit 1533, is provided for selecting the setting of the first voltage divider 1531. If the switch Sw1 is switched accordingly, the first voltage divider 1531 sets the receive threshold T1 of FIG. 4, otherwise the first voltage divider 1531 sets the receive threshold T3 of FIG. 4. For this purpose, the switch Sw1 can be provided to switch a path to a resistor to ground (terminal 44) in such a way that is conductive, for example, in order to set the receive threshold T1 of FIG. 4. If the switch Sw1 then switches the path to the resistor to ground (terminal 44) in such a way that is non-conductive, the third receive threshold T3 of FIG. 4 is set.

The outputs of the second voltage divider 1532 are connected to the inputs of the second input filter 1521. The second voltage divider 1532 can set the receive threshold T2 of FIG. 4, for instance.

The circuit of the resistors in the resistor networks of the voltage dividers 1531, 1532 is symmetrical.

To comply with the requirement of the input resistance Rin at CANH and CANL, the voltage dividers 1531, 1532 each have two resistor paths, namely one for the terminal CANH and one for the terminal CANL. In this case, Rin CANH and Rin CANL=25 kOhm . . . 50 kOhm. An input resistance Rin of 37.5 kOhm is typically selected for the connection (Pin) CANH for the signal CAN_H and for the connection (Pin) CANL for the signal CAN_L.

The switching unit Sw1 can be a transistor, in particular an NMOS transistor. The abbreviation “NMOS” refers an n-channel MOSFET, wherein the abbreviation “MOSFET” stands for metal oxide field effect transistor.

The voltage dividers 1531, 1532 form a dual divider structure. The voltage dividers 1531, 1532 divide the bus voltages that are generated by the signals CAN_H, CAN_L down to values that can be processed by the comparator lines 151, 152.

The dual divider structure of the receive stage 15 makes it possible to check two different receive thresholds of the receive thresholds T1, T2, T3 independently of one another and thus also at the same time or simultaneously. The switching unit Sw1, controlled by the operating mode setting unit 1533, can moreover be used to switch between two receive thresholds of the receive thresholds T1, T2, T3. As a result, either the receive thresholds T1, T2 according to FIG. 4 can be checked independently of one another and simultaneously, or the receive thresholds T1, T3 according to FIG. 4 can be checked independently of one another and simultaneously. Two of the three receive thresholds T1, T2, T3 can therefore be switched to the third receive threshold as required.

The operating mode setting unit 1533 thus sets the receive thresholds T1, T2, T3 according to the currently required operating mode (SLOW, FAST_TX, FAST_RX) of the transceiver 12. In the example described above, the following applies:

TABLE 2
Assignment of comparator output signals and receive thresholds

| | detected receive | Detected receive |
|---|---|---|
| Signal | threshold phase 451 | threshold phase 452 |
| CA1 | T1 | T3 |
| CA2 | T2 | — |

For the preceding example, this specifically means that only a single receive threshold, the receive threshold T3, is checked when the transceiver 12 itself is in a FAST operating mode (FAST_TX, FAST_RX), i.e. during the data phase 452. The first receive comparator line 151 is used for this, and switched to the receive threshold T3 (typically VDIFF=0 V). During the arbitration phase 451, on the other hand, the two receive comparator lines 151, 152 are used.

The second comparator 1522 can, for instance, be set to detect signals on the bus 40 in the data phase 452 having a typical bit time t_bt2 (FIG. 3) of 50 ns. In this case, the states L0/L1 in the data phase 452 are transmitted or sent at a transmission rate of 20 Mbit/s. This requires very high bandwidth for the second comparator 1522.

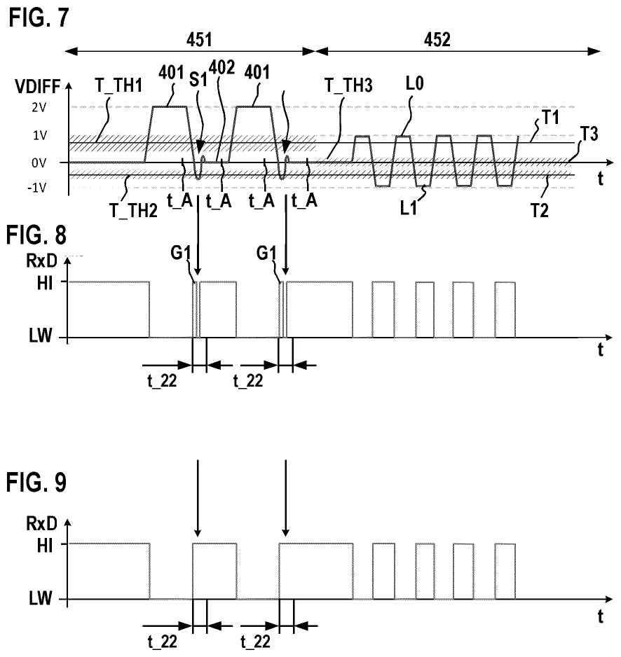

If the transceiver 12 is currently a receiving node, i.e. another subscriber station 10, 20, 30 on the bus 40 is transmitting the message 45 to bus 40, the following applies. When an L1 state with t_bt2=50 ns (FIG. 3) is detected, the second comparator 1522 has to acknowledge this at its output in the signal CA2 with a pulse of at least 15 ns, as specified in the CiA610-3 standard. As a result, when there is a transition from a low-ohmic dominant state 401 to a comparatively high-ohmic recessive state 402, oscillations S1 occur in the differential voltage VDIFF on the bus 40 as shown in FIG. 7.

If the masking block 155 is not active, the reception signal driver 1221 outputs a reception signal RxD as shown in FIG. 8. Due to the required high bandwidth of the second comparator 1522, the undershoots (oscillation S1) of FIG. 7 appear in the form of dominant glitches G1 at the output RXD in the reception signal RxD as shown in FIG. 8. The glitches G1 are small disturbances that are visible at the output RXD in the reception signal RxD. In the example of FIG. 8, all of the undershoots (oscillation S1) of FIG. 7 are depicted in the RxD signal and thus visible to the communication control device 11.

Depending on the topology and the oscillation period, the undesirable glitches G1 can occur in the reception signal RxD up to the sample point t_A. The glitches G1 distort the reception signal RxD, which can disrupt communication in the bus system 1.

However, if the masking block 155 is active, the reception signal driver 1221 outputs a reception signal RxD as shown in FIG. 9. In the resulting reception signal of FIG. 9, all of the undershoots (oscillation S1) of FIG. 7 are masked out and therefore not depicted in the RxD signal of FIG. 9, and are thus also not visible to the communication control device 11.

In the receiver module 122 of FIG. 6, the output signal CA2 of the second comparator 1522 is output to the masking block 155, in particular its timing element 1551.

According to a first possibility, the timing element 155 causes the output of the second comparator 1522 to always be masked out for a predetermined masking time t_22 by default whenever the system enters a recessive bus state in which the receive threshold T1 is undershot and detection is carried out with the first comparator 1512. Therefore, the undershoots (oscillation S1) in the differential voltage VDIFF of FIG. 7 are “overlooked” by the second comparator 1522 and not signaled on the RxD as shown in FIG. 9. The output of the second comparator 1522 is only enabled again after the predetermined time t_22 has elapsed. The second comparator line 152 is thus quick and able to comply with the values required in the CiA610-3 standard.

Due to the masking block 155, the second comparator 1522 thus does not by default have the high bandwidth in the first communication phase 451 or in the first operating mode (SLOW phase) to detect at least 15 ns at the output from a 50 ns wide bit on the bus 40.

The nominal value of the predetermined masking time t_22 can be approximately 500 ns, for instance. The value for the predetermined masking time t_22 can be or is configured in the transceiver 12. This is advantageous because the differential undershoots (oscillation S1) in the differential voltage VDIFF of FIG. 7 also depend, among other things, on the bus topology such as the number of stub lines, star topology, etc.

Alternatively, the value for the predetermined masking time t_22 can be set automatically in the transceiver 12.

According to a second possibility, the following applies. If the receive threshold T1a is exceeded in the transceiver 12 by a message 45 that was transmitted by another subscriber station 10, 20, 30 of the bus system 1, either a dominant or an L0 bus state is present. It has thus been detected in the transceiver 12 that communication is taking place on the bus 40. The reception signal RxD consequently goes to the value LW (LOW), as a result of which the communication control device 11 detects that the bus 40 is occupied.

According to a third possibility, the following applies. If the receive threshold T1 is not exceeded, either a low L0 state may have been transmitted by another subscriber station 10, 20, 30 of the bus system 1, which L0 state was not detected with the receive threshold T1, or the bus 40 is really recessive and therefore free. Thus, after the predetermined time t_22 has elapsed, the measurement is carried out with the second comparator 1522, i.e. with the high bandwidth. The L1 states in the signal on the bus 40 can therefore be reliably detected by the second comparator 1522.

This means that the masking block 155 can always ensure correct identification of the individual communication phases 451, 452 on the bus 40 with the aid of the timing element 1551 and the logic circuit 1552, even in receiving nodes, and even if the physical layer is switched between the communication phases 451, 452 to transmit signals CAN_H, CAN_L to the bus 40.

This enables a high data transmission rate on the bus 40 and thus very efficient operation of the bus system 1.

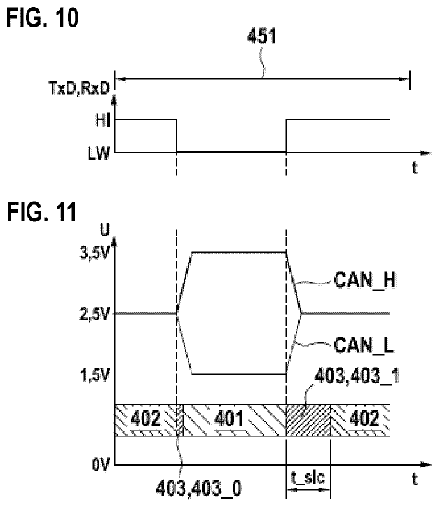

According to a second embodiment example, the transmitter module 121 generates the signals CAN_H, CAN_L for the two communication phases on the bus 40 as described in the following with reference to FIG. 10 to FIG. 13.

FIG. 10 shows an example of a part of the digital transmission signal TxD, which the transmitter module 121 receives from the communication control device 11 in the arbitration phase 451 and from which it generates the signals CAN_H, CAN_L for the bus 40. In FIG. 10, the transmission signal TxD switches from a state LW (Low) to a state HI (High) and back again to the state LW (Low).

The reception signal RxD is ideally identical to the transmission signal TxD. In such an ideal case, there is no transmission delay/runtime, in particular via the bus 40, and no possible reception error.

As shown in more detail in FIG. 11, transmitter module 121 can generate the signals CAN_H, CAN_L of FIG. 11 for the transmission signal TxD from FIG. 10 in the CAN SIC or CAN XL operating mode for the bus wires 41, 42. In contrast to FIG. 3, the signals of FIG. 11 also have a state 403 (sic). The state 403 (sic) can have different lengths, as shown with the state 403_0 (sic) during the transition from the state 402 (rec) into the state 401 (dom) and with the state 403_1 (sic) during the transition from the state 401 (dom) into the state 402 (rec).

The state 403_0 (sic) is shorter in terms of time than the state 403_1 (sic). To generate signals according to FIG. 11, the transmitter module 121 is switched into a SIC operating mode (SIC mode).

Going through the short sic state 403_0 is not required according to the CiA610-3 standard for CAN XL and the state depends on the type of implementation. The time duration of the “long” state 403_1 (sic) is specified as t_sic<530 ns for CAN SIC and also for the SIC operating mode in CAN XL, starting with the rising edge of the transmission signal TxD of FIG. 10.

In the “long” state 403_1 (sic), the transmitter module 121 should adjust the impedance between the bus wires 41 (CANH) and 42 (CANL) as well as possible to the characteristic wave impedance Zw of the bus line being used. Zw=100 ohm or 120 ohm applies here. This adjustment prevents reflections and thus allows operation at higher bit rates. For the sake of simplicity, this is always referred to in the following as the state 403 (sic) or sic state 403.

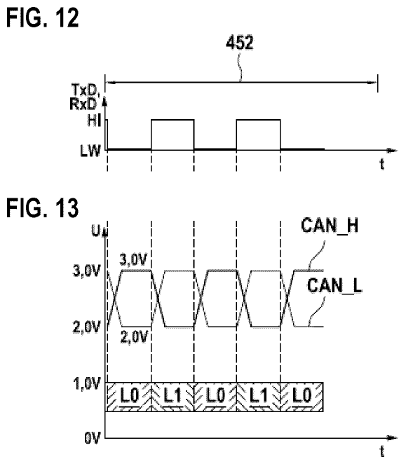

FIG. 12 shows an example of another part of the digital transmission signal TxD, which the transmitter module 121 according to the second embodiment example receives from the communication control device 11 (FIG. 1) in the data phase 452 and from which it generates the signals CAN_H, CAN_L for the bus 40. In FIG. 12, the transmission signal TxD switches several times from the state HI (High) to a state LW (Low) and back to a state HI (High) and so on.

As shown in more detail in FIG. 13, the transmitter module 121 generates the signals CAN_H, CAN_L for the bus wires 41, 42 for the transmission signal TxD of FIG. 12 in such a way that the state L0 forms for a state LW (Low). In addition, the state L1 forms for a state HI (High).

It is possible that no dominant and recessive bus state is used for the two bus states L0, L1, at least temporarily, but instead a first bus state and a second bus state are used, both of which are driven. An example of such a bus system is a CAN XL bus system.

The receiver module 122 can also receive the signals according to FIG. 11 and FIG. 13 in the two different communication phases, namely the SIC operating mode or arbitration phase 451 and the data phase 452. For this purpose, the receiver module 122 switches the receive thresholds T1, T3 for the respective operating modes, as described above with reference to the preceding embodiment example.

The operating mode setting unit 1533 thus sets the receive thresholds T1, T2, T3 according to the currently required operating mode (SIC, FAST_TX, FAST_RX) of the transceiver 120.

In this way, too, the comparator lines 151, 152 can be operated very advantageously with the masking block 155 of FIG. 6.

All of the above-described configurations of the transceiver 12, the transmitter module 121, the receiver module 122, the subscriber stations 10, 20, 30, the bus system 1, and the method carried out therein according to the first and second embodiment example and their modifications can be used alone or in all possible combinations. In particular the following modifications are possible as well.

The above-described bus system 1 according to the first and second embodiment example is described with reference to a bus system based on the CAN protocol. However, the bus system 1 according to the first and/or second embodiment example can alternatively be another type of communication network in which the signals are transmitted as differential signals. It is advantageous, but not necessarily a prerequisite, that exclusive, collision-free access of a subscriber station 10, 20, 30 to the bus 40 is ensured in the bus system 1 at least for certain periods of time.

The bus system 1 according to the first and/or second embodiment example and their modifications is in particular a CAN bus system or a CAN HS bus system or a CAN FD bus system or a CAN SIC bus system or a CAN XL bus system. However, the bus system 1 can be another communication network in which the signals are transmitted as differential signals and serially via the bus 40.

Thus, the functionality of the above-described embodiment examples can, for example, be used in transceivers 12, 22 that can be operated in a CAN bus system or a CAN HS bus system or a CAN FD bus system or a CAN SIC bus system or a CAN XL bus system.

The number and arrangement of the subscriber stations 10, 20, 30 in the bus system 1 according to the first and second embodiment example and their modifications is freely selectable. In particular, only subscriber stations 10 or only subscriber stations 30 are present in the bus systems 1 of the first or second embodiment example.

1-15. (canceled)

16. A transceiver for a subscriber station of a serial bus system, in which differential signals are generated on a bus of the bus system are generated in a first communication phase of a communication on the bus with a first physical layer and in a second communication phase of the communication on the bus with a second physical layer, the transceiver comprising:
a first comparator configured to evaluate the differential signals received from the bus with a first receive threshold in the first communication phase and to evaluate differential signals received from the bus with a third receive threshold in the second communication phase, wherein the first comparator is configured to output an output signal in order to output a digital reception signal to a communication control device of the subscriber station;
a second comparator configured to evaluate the differential signals received from the bus with a second receive threshold in the first communication phase for a reception signal driver; and
a masking block configured to generate a masked comparator signal that is an intermittently masked output signal of the second comparator and to generate an output signal from the masked comparator signal and the output signal of the first comparator for the reception signal driver.

17. The transceiver according to claim 16, wherein the masking block includes:
a timing element connected to an output of the second comparator and is configured to output the masked comparator signal; and
a logic circuit configured to generate a signal from the output signal of the first comparator and the masked comparator signal for output to the reception signal driver.

18. The transceiver according to claim 17, wherein the logic circuit is an AND gate to serially form a logical AND connection of the output signal of the first comparator and the masked comparator signal.

19. The transceiver according to claim 16, further comprising:
a driver configured to drive a digital reception signal to a communication control device of a subscriber station of the bus system; and
a reception signal logic circuit configured to forward an output signal from a first comparator line including the first comparator and an output signal from a second comparator line including the second comparator to the driver when the communication is taking place in the first communication phase, and to forward only the output signal from the first comparator line to the driver when the communication is taking place in the second communication phase.

20. The transceiver according to claim 16, further comprising:
a first voltage divider which is connected to the bus and outputs the differential signals received from the bus to the first comparator; and
a second voltage divider which is connected to the bus and outputs the differential signals received from the bus to the second comparator.

21. The transceiver according to claim 20, wherein:
the first and second voltage divider include a circuit of resistors to which the first and second comparator are connected, and
the first and second comparator evaluate the differential signals simultaneously.

22. The transceiver according to claim 20, wherein:
the first voltage divider includes a switch which is provided to set the first receive threshold for the first voltage divider in a first switch position and to set the third receive threshold for the first voltage divider in a second switch position; and
the second voltage divider is configured to set the second receive threshold.

23. The transceiver according to claim 22, wherein the switch is provided to connect or disconnect a resistor to ground.

24. The transceiver according to claim 22, wherein the switch is an NMOS transistor.

25. The transceiver according to claim 22, wherein:
the transceiver is configured to output the output signal of the second comparator to the reception signal driver when the switch in the first switch position has set the first receive threshold in the first voltage divider; and
the transceiver is configured to not output the output signal of the second comparator to the reception signal driver when the switch in the second switch position has set the third receive threshold in the first voltage divider.

26. The transceiver according to claim 22, further comprising:
an operating mode setting unit configured to control the switch to switch the first voltage divider between the first receive threshold and the third receive threshold depending on whether the first communication phase or the second communication phase is taking place on the bus.

27. The transceiver according to claim 16, further comprising a transmitter module configured to transmit signals to a bus of the bus system.

28. A subscriber station for a serial bus system, comprising:
a transceiver, including:
a first comparator configured to evaluate the differential signals received from the bus with a first receive threshold in the first communication phase and to evaluate differential signals received from the bus with a third receive threshold in the second communication phase, wherein the first comparator is configured to output an output signal in order to output a digital reception signal to a communication control device of the subscriber station,
a second comparator configured to evaluate the differential signals received from the bus with a second receive threshold in the first communication phase for a reception signal driver,
a masking block configured to generate a masked comparator signal that is an intermittently masked output signal of the second comparator and to generate an output signal from the masked comparator signal and the output signal of the first comparator for the reception signal driver, and
a transmitter module configured to transmit signals to a bus of the bus system; and
the communication control device, the communication control device configured to control the communication in the bus system to generate a digital transmission signal for the transmitter module.

29. The subscriber station according to claim 28, wherein the subscriber station is configured for communication in the bus system in which exclusive, collision-free access of a subscriber station to the bus of the bus system is ensured at least temporarily.

30. A method for receiving differential signals in a serial bus system, in which differential signals are generated on a bus of the bus system in a first communication phase of a communication on the bus with a first physical layer, and in a second communication phase of the communication on the bus with a second physical layer, the method comprising the following steps:
receiving, with a transceiver, differential signals from the bus;
evaluating, with a first comparator, the differential signals received from the bus with a first receive threshold in the first communication phase;
evaluating, with the first comparator, the differential signals received from the bus with a third receive threshold in the second communication phase, wherein the first comparator outputs a digital reception signal to a communication control device of the subscriber station in order to output an output signal in the first communication phase and the second communication phase;
evaluating, with a second comparator, the differential signals received from the bus with a second receive threshold in the first communication phase for a reception signal driver;
generating, with a masking block, a masked comparator signal that is an intermittently masked output signal of the second comparator; and
generating, with the masking block, an output signal from the masked comparator signal and the output signal of the first comparator for the reception signal driver.
